(19) United States
(12) Patent Application Publication
(10) Pub. No.: US 2016/0268961 A1
(43) Pub. Date: Sep. 15, 2016

(54) SOLAR ENERGY ELECTRIC MACHINE

(71) Applicant: Larry L. King, Jacksonville, FL (US)

(72) Inventor: Larry L. King, Jacksonville, FL (US)

(21) Appl. No.: 14/641,539

(22) Filed: Mar. 9, 2015

(51) Int. Cl. H02S 20/32

(52) U.S. Cl. CPC H02S 20/32

(57) ABSTRACT

A solar energy device that includes: a first platform, where the first platform includes at least two support posts which support the first platform; a rotating horizontal platform supported by the first platform; a rotational motor engaged under the rotating horizontal platform, where the rotational motor rotates the horizontal platform in a circular motion; a wheel mounted on the rotating horizontal platform, where the wheel is supported by two wheel support posts; a solar panel mounted on an outer perimeter of the wheel; and a wheel motor engaged with the wheel, where the wheel motor rotates the wheel. Preferably, the horizontal platform rotates in alignment with the movement of the sun and the wheel rotates to align the solar panel with the sun. Upon sunset, the wheel resets to a starting position, where the starting position is in alignment with sunrise.

### BACKGROUND OF THE INVENTION

1. Field of Invention

This particular invention relates to a solar energy system that includes a rotating solar panel that rotates with the movement of the sun.

2. Description of Related Art

Alternative energy sources are necessary to reduce dependence on fossil fuels and to meet current energy consumption demands. The primary energy sources include fossil fuels and other non-renewable energy sources such as natural gas, coal and petroleum products. Although these are the major sources of energy these energy sources are non-renewable and therefore rapidly being depleted due to the vast demand for the energy sources. As a result many companies, scientists and others are investigating ways of implementing renewable sources such as wind and solar energy. As a consequence, it is always advantageous to have suitable systems to address needs in solar renewable energy. Solar energy relies upon sunlight in particular ultraviolet rays from the sun. One drawback to the solar energy is the limited amount of sunlight days and in certain instances solar panels need to be optimized to collect solar energy. Therefore any improvements with respect to positioning of a solar panel for the collection of solar energy would be advantageous to the movement toward renewable energy sources.

### SUMMARY OF THE INVENTION

The present invention relates to a solar energy device that includes: a first platform, where the first platform includes at least two support posts which support the first platform; a rotating horizontal platform supported by the first platform; a rotational motor engaged under the rotating horizontal platform, where the rotational motor rotates the horizontal platform in a circular motion; a wheel mounted on the rotating horizontal platform, where the wheel is supported by two wheel support posts; a solar panel mounted on an outer perimeter of the wheel; and a wheel motor engaged with the wheel, where the wheel motor rotates the wheel. Preferably, the horizontal platform rotates in alignment with the movement of the sun and the wheel rotates to align the solar panel with the sun. Upon sunset, the wheel resets to a starting position, where the starting position is in alignment with sunrise.

### BRIEF DESCRIPTION OF DRAWINGS

FIG. 1 depicts a front view of a solar energy machine in accordance with the present invention.

FIG. 2 depicts a side view of the solar energy machine in accordance with the present invention.

### DETAILED DESCRIPTION

The present invention relates to a solar energy machine, which provides an operating system to position solar panels in optimum position throughout a day. The present invention rotates a solar panel to coordinate with the movement of the sun over the course of a day. The present invention includes a wheel that has a solar panel mounted on one side thereof. The wheel rotates in coordination with the movement of the sun during the course of the day in order to optimize the position of the solar panel to effectively receive ultraviolet rays throughout the period of the day. Once the sun has set the wheel resets to a starting position that is coordinated with the sunrise and upon sunrise the wheel moves in accordance with the sun.

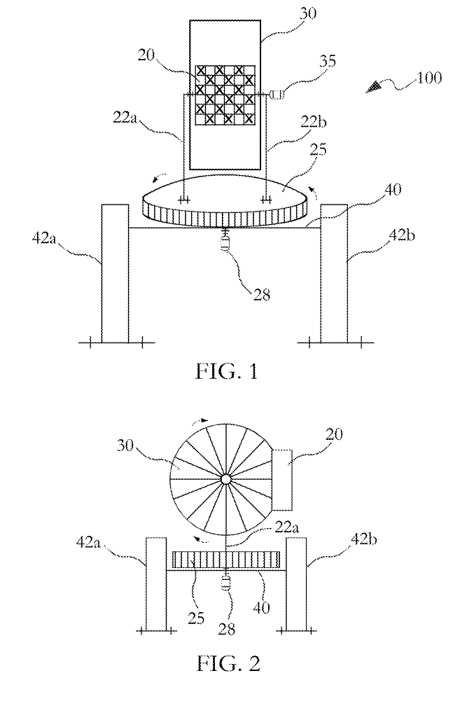

In reference to FIG. 1, a front view of a solar energy machine 100 according to the present invention is depicted. The solar energy machine 100 includes a lower platform 40 that is supported by platform support posts 42a, 42b. This platform 40 supports a rotating horizontal platform 25 that includes a second rotational motor 28 under the rotating platform 25. On top of the platform 25 include support posts 22a, 22b, which support a rotating wheel 30. The rotating wheel 30 includes a solar panel 20 on the outer perimeter of the wheel 30. A first motor 35 as shown in FIG. 1 rotates the wheel 30. This rotating wheel 30 enables the movement of the solar panel 20 in coordination with the sun over the horizon. The sun rises over the east horizon, and then moves across the sky into the west horizon at sunset. This movement of sun therefore may interfere with the collection of ultraviolet rays emitted over the course of the day. Advantageous to the present invention rotates solar panel 20 in sync with the movement of sun over the day.

In reference to FIG. 2, a side view of the solar energy machine according to the present invention is depicted. This side view shows movement of the wheel 30 across the horizontal plane by use of the rotating platform 25. The platform 25 rotates in a circular manner across the horizontal plane. FIG. 2 depicts a side view of the wheel 30 and solar panel 20 incorporated on the perimeter of the wheel 30. Based upon the horizontal and vertical planes of movement the solar energy machine 100 follows the path of the sun to optimize the position of the solar panel 20. The present invention provides a unique renewable energy source due to the rotation of the solar panels on the wheel provided. The wheel 30 as shown in the solar energy machine rotates and may be equipped appropriate sensors positioned on both platforms to optimize the rotation of the wheel 30 and the rotating platform 25. The present invention provides an effective solar energy source through the use of the rotational platform and wheel. The instant invention has been shown and described in what it considers to be the most practical and preferred embodiments. It is recognized, however, that departures may be made there from within the scope of the invention and that obvious modifications will occur to a person skilled in the art.

What is claimed is:

1. A solar energy device comprising:
a. a first platform, where the first platform includes at least two support posts which support the first platform;
b. a rotating horizontal platform supported by the first platform;
c. a rotational motor engaged under the rotating horizontal platform, where the rotational motor rotates the horizontal platform in a circular motion;
d. a wheel mounted on the rotating horizontal platform, where the wheel is supported by two wheel support posts;
e. a solar panel mounted on an outer perimeter of the wheel; and
f. a wheel motor engaged with the wheel, where the wheel motor rotates the wheel.

2. The solar energy device according to claim 1, where the horizontal platform rotates in alignment with the movement of the sun.

3. The solar energy device according to claim 1, where the wheel rotates to align the solar panel with the sun.

4. The solar energy device according to claim 1, where the wheel resets to a starting position upon sunset.

5. The solar energy device according to claim 4, where the starting position is in alignment with sunrise.
